(19) United States
(12) Patent Application Publication
(10) Pub. No.: US 2017/0193433 A1
(43) Pub. Date: Jul. 6, 2017

(54) SYSTEM FOR ESTIMATING GEOGRAPHICAL DEMAND AND METHOD THEREFOR

(71) Applicant: WAL-MART STORES, INC., Bentonville, AR (US)

(72) Inventors: Zhiwei Qin, San Jose, CA (US); Long He, Daly City, CA (US)

(73) Assignee: WAL-MART STORES, INC., Bentonville, AR (US)

(21) Appl. No.: 14/988,246

(22) Filed: Jan. 5, 2016

(51) Int. Cl. G06Q 10/08; G06N 7/00

(52) U.S. Cl. CPC G06Q 10/087; G06Q 10/083; G06N 7/005

(57) ABSTRACT

A system and method for estimating geographical demand for new items is presented. A system can include one or more processing modules and one more non-transitory storage modules. Information is received about existing SKUs and associated attributes. Demand is determined by geographic zone. When a new SKU is added, geographic demand for the new SKU is estimated using the attributes of the new SKU. The new SKU can be allocated according to the estimation. Other embodiments are also disclosed herein.

### TECHNICAL FIELD

This disclosure relates generally to product distribution systems, and relates more particularly to managing inventory across a fulfillment network of multiple distribution centers.

### BACKGROUND

Online retail has become mainstream, which has allowed customers to order an increasing number of products online and receive direct shipments of the items they order. These products are often shipped from warehouses, also known as distribution centers. Although an online retailer may market and sell many distinct items, also known as stock keeping units (SKUs), each distribution center generally has a limited capacity and, thus, can carry only a limited number of SKUs. As such, stocking each SKU at every distribution center is generally unfeasible. In general, SKUs are placed in distribution centers in an attempt to minimize outbound shipping costs, guarantee service levels, and prevent the overloading of any one distribution center. It would be desirable to have a system and method of allocating SKUs to distribution centers in an efficient manner.

### BRIEF DESCRIPTION OF THE DRAWINGS

To facilitate further description of the embodiments, the following drawings are provided in which:

FIG. 1 illustrates a front elevational view of a computer system that is suitable for implementing an embodiment of the system disclosed in FIG. 3;

FIG. 2 illustrates a representative block diagram of an example of the elements included in the circuit boards inside a chassis of the computer system of FIG. 1;

FIG. 3 illustrates a block diagram of an exemplary online retail system, portions of which can be employed for determining an inventory mirroring plan, according to an embodiment;

FIG. 4 illustrates a flow chart for an exemplary method of performing an embodiment; and

FIG. 5 illustrates a block diagram of an example of an inventory system, according to the embodiment of FIG. 4.

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

### DESCRIPTION OF EXAMPLES OF EMBODIMENTS

A number of embodiments can include a system. The system can comprise one or more processing modules; and one or more non-transitory memory storage modules storing computing instructions configured to run on the one or more processing modules. The computing instructions can be configured to perform the acts of receiving information regarding a set of SKUs; receiving information regarding attributes for each SKU in the set of SKUs; calculating overall demand per zone; calculating demand per zone for each SKU; receiving information regarding a new SKU N+1; receiving information regarding a set of attributes for the new SKU N+1; estimating demand per zone for SKU N+1; and allocating the new SKU N+1 to one or more distribution centers based on the estimated demand per zone for SKU N+1.

Various embodiments include a method. The method can comprise: receiving information regarding a set of SKUs; receiving information regarding attributes for each SKU in the set of SKUs; calculating overall demand per zone; calculating demand per zone for each SKU; receiving information regarding a new SKU N+1; receiving information regarding a set of attributes for the new SKU N+1; estimating demand per zone for SKU N+1; and allocating the new SKU N+1 to one or more distribution centers based on the estimated demand per zone for SKU N+1.

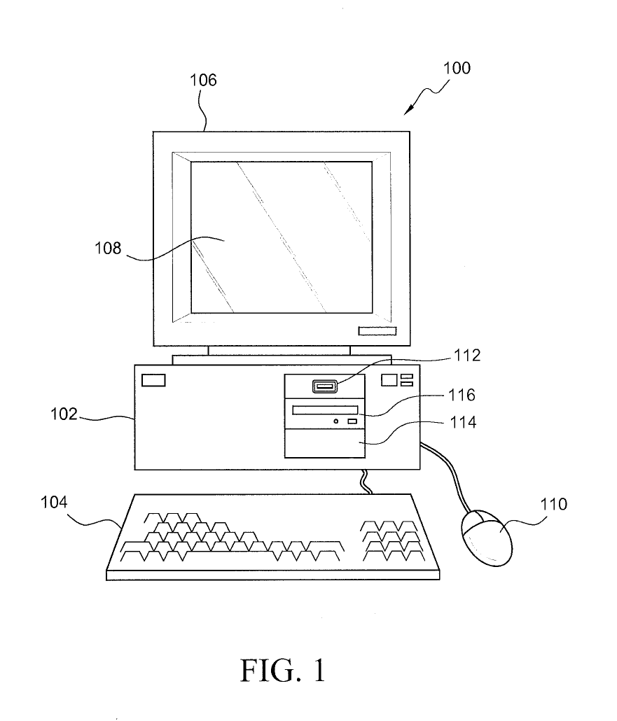

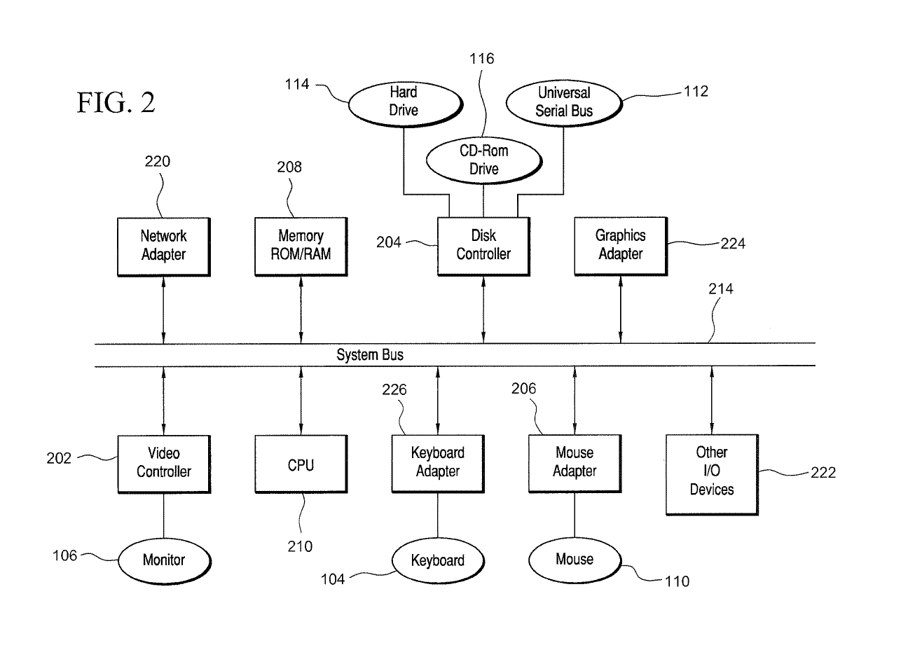

Turning to the drawings, FIG. 1 illustrates an exemplary embodiment of a computer system 100, all of which or a portion of which can be suitable for implementing the techniques described herein. As an example, a different or separate one of a chassis 102 (and its internal components) can be suitable for implementing the techniques described herein. Furthermore, one or more elements of computer system 100 (e.g., a refreshing monitor 106, a keyboard 104, and/or a mouse 110, etc.) can also be appropriate for implementing the techniques described herein. Computer system 100 comprises chassis 102 containing one or more circuit boards (not shown), a Universal Serial Bus (USB) port 112, a Compact Disc Read-Only Memory (CD-ROM) and/or Digital Video Disc (DVD) drive 116, and a hard drive 114. A representative block diagram of the elements included on the circuit boards inside chassis 102 is shown in FIG. 2. A central processing unit (CPU) 210 in FIG. 2 is coupled to a system bus 214 in FIG. 2. In various embodiments, the architecture of CPU 210 can be compliant with any of a variety of commercially distributed architecture families.

Continuing with FIG. 2, system bus 214 also is coupled to a memory storage unit 208, where memory storage unit 208 comprises both read only memory (ROM) and random access memory (RAM). Non-volatile portions of memory storage unit 208 or the ROM can be encoded with a boot code sequence suitable for restoring computer system 100 (FIG. 1) to a functional state after a system reset. In addition, memory storage unit 208 can comprise microcode such as a Basic Input-Output System (BIOS). In some examples, the one or more memory storage units of the various embodiments disclosed herein can comprise memory storage unit 208, a USB-equipped electronic device, such as, an external memory storage unit (not shown) coupled to universal serial bus (USB) port 112 (FIGS. 1-2), hard drive 114 (FIGS. 1-2), and/or CD-ROM or DVD drive 116 (FIGS. 1-2). In the same or different examples, the one or more memory storage units of the various embodiments disclosed herein can comprise an operating system, which can be a software program that manages the hardware and software resources of a computer and/or a computer network. The operating system can perform basic tasks such as, for example, controlling and allocating memory, prioritizing the processing of instructions, controlling input and output devices, facilitating networking, and managing files. Some examples of common operating systems can comprise Microsoft® Windows® operating system (OS), Mac® OS, UNIX® OS, and Linux® OS.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processors of the various embodiments disclosed herein can comprise CPU 210.

In the depicted embodiment of FIG. 2, various I/O devices such as a disk controller 204, a graphics adapter 224, a video controller 202, a keyboard adapter 226, a mouse adapter 206, a network adapter 220, and other I/O devices 222 can be coupled to system bus 214. Keyboard adapter 226 and mouse adapter 206 are coupled to keyboard 104 (FIGS. 1-2) and mouse 110 (FIGS. 1-2), respectively, of computer system 100 (FIG. 1). While graphics adapter 224 and video controller 202 are indicated as distinct units in FIG. 2, video controller 202 can be integrated into graphics adapter 224, or vice versa in other embodiments. Video controller 202 is suitable for refreshing monitor 106 (FIGS. 1-2) to display images on a screen 108 (FIG. 1) of computer system 100 (FIG. 1). Disk controller 204 can control hard drive 114 (FIGS. 1-2), USB port 112 (FIGS. 1-2), and CD-ROM drive 116 (FIGS. 1-2). In other embodiments, distinct units can be used to control each of these devices separately.

In some embodiments, network adapter 220 can comprise and/or be implemented as a WNIC (wireless network interface controller) card (not shown) plugged or coupled to an expansion port (not shown) in computer system 100 (FIG. 1). In other embodiments, the WNIC card can be a wireless network card built into computer system 100 (FIG. 1). A wireless network adapter can be built into computer system 100 by having wireless communication capabilities integrated into the motherboard chipset (not shown), or implemented via one or more dedicated wireless communication chips (not shown), connected through a PCI (peripheral component interconnector) or a PCI express bus of computer system 100 (FIG. 1) or USB port 112 (FIG. 1). In other embodiments, network adapter 220 can comprise and/or be implemented as a wired network interface controller card (not shown).

Although many other components of computer system 100 (FIG. 1) are not shown, such components and their interconnection are well known to those of ordinary skill in the art. Accordingly, further details concerning the construction and composition of computer system 100 and the circuit boards inside chassis 102 (FIG. 1) are not discussed herein.

When computer system 100 in FIG. 1 is running, program instructions stored on a USB-equipped electronic device connected to USB port 112, on a CD-ROM or DVD in CD-ROM and/or DVD drive 116, on hard drive 114, or in memory storage unit 208 (FIG. 2) are executed by CPU 210 (FIG. 2). A portion of the program instructions, stored on these devices, can be suitable for carrying out at least part of the techniques described herein.

Although computer system 100 is illustrated as a desktop computer in FIG. 1, there can be examples where computer system 100 may take a different form factor while still having functional elements similar to those described for computer system 100. In some embodiments, computer system 100 may comprise a single computer, a single server, or a cluster or collection of computers or servers, or a cloud of computers or servers. Typically, a cluster or collection of servers can be used when the demand on computer system 100 exceeds the reasonable capability of a single server or computer. In certain embodiments, computer system 100 may comprise a portable computer, such as a laptop computer. In certain other embodiments, computer system 100 may comprise a mobile device, such as a smart phone or a tablet. In certain additional embodiments, computer system 100 may comprise an embedded system.

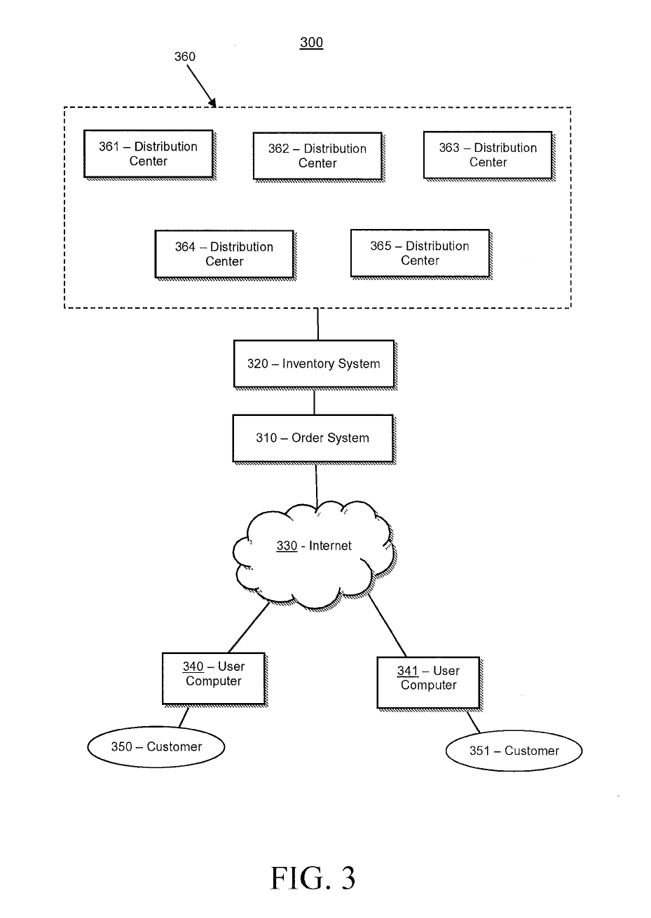

Turning ahead in the drawings, FIG. 3 illustrates a block diagram of an exemplary online retail system 300, portions of which can be employed for determining an inventory mirroring plan, according to an embodiment. Online retail system 300 is merely exemplary of a system in which an online retailer can receive and fulfill online orders, and embodiments of the online retail system and elements thereof are not limited to the embodiments presented herein. The online retail system and elements thereof can be employed in many different embodiments or examples not specifically depicted or described herein. In some embodiments, certain elements or modules of online retail system 300 can perform various procedures, processes, and/or activities. In other embodiments, the procedures, processes, and/or activities can be performed by other suitable elements or modules of online retail system 300.

In a number of embodiments, online retail system 300 can include a fulfillment network 360. In various embodiments, fulfillment network 360 can include one or more distribution centers, such as distribution centers (also known as fulfillment centers) 361, 362, 363, 364, and 365. In various embodiments, there can be 10, 15, 20, 30, 40, 50, or another suitable number of distribution centers. In some embodiments, online retail system 300 can include an order system 310 and/or an inventory system 320. Inventory system 320 and/or order system 310 can each be a computer system, such as computer system 100 (FIG. 1), as described above, and can each be a single computer, a single server, or a cluster or collection of computers or servers, or a cloud of computers or servers. In some embodiments, inventory system 320 can track the distinct items (e.g., stock keeping units (SKUs)) which can be ordered through the online retailer and which can be housed at the distribution centers (e.g., 361-365) of fulfillment network 360.

In many embodiments, inventory system 320 can be in data communication with order system 310. In certain embodiments, inventory system 320 and order system 310 can be separate systems. In other embodiments, inventory system 320 and order system 310 can be a single system. In various embodiments, order system 310 can be in data communication through Internet 330 with user computers (e.g., 340, 341). User computers 340-341 can be desktop computers, laptop computers, smart phones, tablet devices, and/or other endpoint devices, which can allow customers (e.g., 350-351) to access order system 310 through Internet 330. In various embodiments, order system 310 can host one or more websites, such as through one or more web servers. For example, order system 310 can host an eCommerce website that can allow customers (e.g., 350, 351) to browse and/or search for products, to add products to an electronic shopping cart, and/or to purchase products by completing an online order, in addition to other suitable activities. In other embodiments, order system 310 can utilize mobile apps that allow customers (e.g., 350, 351) to browse and/or search for products, to add products to an electronic shopping cart, and/or to purchase products by completing an online order, in addition to other suitable activities. A combination of mobile apps and websites also can be used.

In various embodiments, an online order for an item submitted by a customer (e.g., 350, 351) can result in a shipment to the customer (e.g., 350, 351) from one of the distribution centers (e.g., 361-365), such as the distribution center that has the item stocked in its inventory and that is located the closest to the delivery address of the customer (e.g., 350, 351) that submitted the online order. In several embodiments, one or more of the distribution centers (e.g., 361-365) can each have a limited capacity and can carry some of the SKUs, but not all of the SKUs, that are available for sale through order system 310. As such, stocking every SKU at every distribution center (e.g., 361-365) can be unfeasible, and the SKUs can instead be stocked strategically in a process sometimes called mirroring.

In mirroring, the distribution centers can be “mirrored” to stock the inventory of each SKU as close as possible to specific customer locations, subject to constraints, such as limited capacity of the distribution centers (e.g., 361-365). In some embodiments, various factors can determine the cost of shipping a SKU, such as demand volume, shipping cost sensitivity, weight, geo-demand (also known as geographic demand) distribution, the number of distribution centers (e.g., 361-365), and/or the capacity of the distribution centers (e.g., 361-365). For example, if a SKU has low sales volume (a “low-velocity” SKU) or very regional demand spread, it might not necessarily warrant a high mirroring because the additional fulfillment cost and time can be small. By contrast, a SKU having high sales volume (a “high-velocity” SKU) with wide geo-demand spread can be stocked at more distribution centers (e.g., 361-365) in order to deliver the ordered inventory of the SKU within a predetermined time, to lower shipping costs, and/or to meet other service-level targets. In many embodiments, inventory system 320 can determine how many distribution centers (e.g., 361-365) at which to mirror each distinct item (e.g., SKU).

In some embodiments, shipping from the distribution centers (e.g., 361-365) to customers (e.g., 350, 351) can be based on a shipping zone system. The shipping zone system can be a representation of shipping distance. For example, a package shipped within the same state can be a 2-zone shipment, whereas a cross-continental shipping can be an 8-zone shipment. An 8-zone shipment has a higher shipping cost than a 2-zone shipment. It can be desirable to have SKUs be placed in the distribution centers in as efficient manner as possible to minimize the shipping costs. Minimizing shipping costs can be important to both customers and to the retailer, as both customers and retailers can be affected by high shipping costs because one or both parties might pay shipping costs. In addition, transit time can be an important decision point for a customer in choosing a retailer.

In many embodiments, determination of an inventory mirroring plan by inventory system 320 can be based on one or more assumptions. For example, fulfillment network 360 can be well established, and the number and locations of the distribution centers (e.g., 361-365) can have good geographic coverage such that mirroring decisions can be meaningful. As another example, the inventory holding cost can be insignificant compared to shipping cost.

In many embodiments, order system 310 can make available for sale a set of distinct items (e.g., SKUs), each of which can be represented by distinct item (i). In some embodiments, the set of distinct items can include each SKU in the catalog of items sold through order system 310. In a number of embodiments, the set of distinct items can be a subset of the catalog, such as general merchandise items, which can exclude such items as clothes, jewelry, tissue paper, etc. In a number of embodiments, an overall approach can be to solve for optimal inventory mirroring as a knapsack-type problem. The distinct items can be analogous to the items to be put into a bag, which can be analogous to the overall capacity of the distribution centers (e.g., 361-365) in fulfillment network 360, which can have a finite capacity. There can be a cost (or value) associated with each distinct item (i) for each mirroring factor, which can represent the number of the distribution center (e.g., 361-365) in fulfillment network 360 to stock with distinct item (i). The objective can be to minimize the total cost, while staying within the total capacity of fulfillment network 360. Hence, the “value” of mirroring a distinct item (i) in a selected number of distribution centers (e.g., 361-365) can be the negative of the expected resulting optimal shipping cost for fulfilling the overall demand of the distinct item (i), assuming cost is represented as a negative value. A challenging component of this framework can be to determine the costs. Computing the exact optimal fulfillment cost associated with a given distinct item (i) and mirroring factor combination can be intractable and/or impossible when there are a very large number of distinct items (i) and/or a large number of distribution centers (e.g., 361-365), and so certain approximations can be used.

In some embodiments, each location can be represented by a demand zone (z), which can collectively comprise a set of demand zones that cover a geographical area, such as the contiguous United States. For example, each demand zone (z) can represent each distinct three-digit ZIP code (e.g., the first three digits of the five-digit ZIP code) in the contiguous United States. In other embodiments, the three-digit ZIP codes can be clustered into a smaller number of demand zones, such as 125 demand zones, as described in U.S. patent application Ser. No. 14/466,239, filed Aug. 22, 2014, the contents of which are hereby incorporated by reference in its entirety.

In a number of embodiments, a total demand for a distinct item (i) across fulfillments network 360 can be represented by dᵢ. In various embodiments, geo-demand distribution can be data that specifies the geographical spread of customer demand for each distinct item (i). Specifically, each distinct item (i) can be associated with a distribution vector whose elements can represent the percentage of demand for a particular geographical location. In various embodiments, the demand distribution can be based on the demand from the previous year, or in other words, time-static. The time-static geo-demand distribution for distinct item (i) at demand zone (z) can be denoted by β_{i,z}. In a number of embodiments, Σ_{z}β_{i,z}=1. In several embodiments, this demand distribution data can be estimated by a number of machine learning and/or statistical methods, such as a Bayesian approach described in U.S. patent application Ser. No. 14/466,239, filed Aug. 22, 2014, the contents of which are hereby incorporated by reference in its entirety. With the estimation of the time-static geo-demand distributions (β_{i,z}), in several embodiments of a location-specific demand (d_{i,z}), d_{i,z}=dᵢβ_{i,z}.

In many embodiments, to minimize the cost of shipping the distinct items (i), with the distinct items (i) being mirrored across a various number of distribution centers (e.g., 361-365), inventory system 320 can select a number of distribution centers (e.g., 361-365) from fulfillment network 360 for each of distinct item (i) that will minimize the cost of shipping. For example, a first distinct item can be mirrored at 5 distribution centers, a second distinct item can be mirrored at 10 distribution centers, etc.

The selection of the number of distribution centers for each of the distinct items (i) can be combinatorial in nature and can be computationally intensive. To alleviate this complexity, inventory system 320 can cluster the distribution centers (e.g., 361-365) into distribution center clusters for each of the possible mirroring selections. For example, inventory system 320 can determine a 1-cluster profile, a 2-cluster profile, a 3-cluster profile, and so forth, to a predetermined maximum number of clusters (K). For example, in some embodiments, the predetermined maximum number of clusters (K) can be 10, 15, 20, or another suitable number. For example, in some embodiments, the clustering can reduce the number of warehouses from 33 down to a maximum of 12 clusters. Each of the clusters can have one or more distribution centers. For a number of clusters (k), the k-cluster profile can be a segmentation of the distribution centers (e.g., 361-365) into k distribution center clusters. The distribution center clustering approximation can work generally well if the geo-demand spread of a distinct item (i) is not particularly skewed.

There can be several different methods in which SKUs can be allocated among different distribution centers, some of which are described above and others of which are described in U.S. patent application Ser. No. 14/466,239, filed Aug. 22, 2014 and in U.S. patent application Ser. No. 14/928,148, filed Oct. 30, 2015, the contents of which are hereby incorporated by reference in its entirety. However, some of those methods involve the use of past sales data for each SKU in question. Such a method might not be applicable, however, for a SKU with no prior sales. There can be a variety of different reasons for a SKU to have no prior sales, such as that the SKU has never been sold by the retailer before, the SKU is a newly offered bundle of other items, an item is available in a new configuration (e.g., new color or size) or the like.

An embodiment that can solve such a problem involves the analysis of one or more attributes of a new SKU. An embodiment can examine the attributes of similar SKUs.

SKUs can be considered similar by one of a variety of different manners. In some embodiments, SKUs can be organized by a retailer into categories. The categories can be broken into sub-categories. For example, one particular retailer has a category called electronics. Within the electronics category, there are a variety of subcategories such as computers, cell phones, audio, and the like. Each of the subcategories can have further levels of subcategories. For example, the computer subcategory can include subcategories such as laptop, desktop, networking, software, and the like. When a new SKU (such as a laptop computer) is released, it is placed in one or more levels of categories and subcategories (such as electronics/computers/laptop).

In some embodiments, each SKU within a category or subcategory can be assigned one or more attributes. Attributes describe certain features of a SKU. For example, with respect to a television, an attribute can include cost, screen size, resolution, and the like. With respect to a laptop, attributes can include, cost, screen size, storage size, operating system, and the like. With respect to a coat, attributes can include brand, color, size, and the like. When a new item is introduced, the geographic demand of similar items can be used to estimate the geographic demand of the new item.

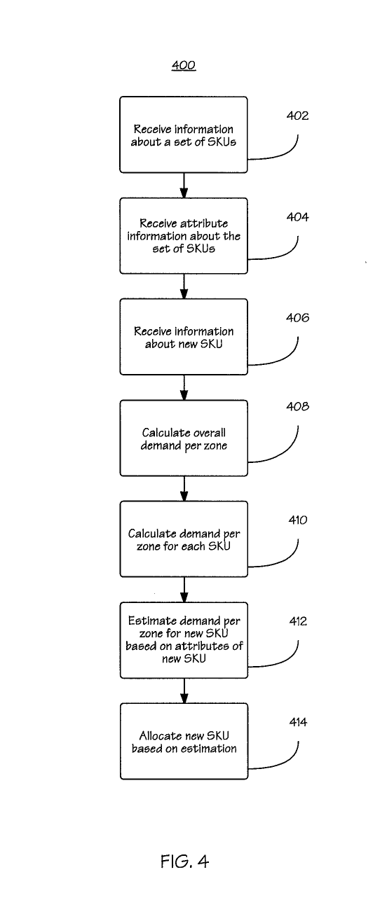

Turning ahead in the drawings, FIG. 4 illustrates a flow chart for a method 400 of allocating an item among multiple distribution centers according to an embodiment. The fulfillment network can be similar or identical to fulfillment network 360 (FIG. 3). Method 400 is merely exemplary and is not limited to the embodiments presented herein. Method 400 can be employed in many different embodiments or examples not specifically depicted or described herein. In some embodiments, the procedures, the processes, and/or the activities of method 400 can be performed in the order presented. In other embodiments, the procedures, the processes, and/or the activities of method 400 can be performed in any suitable order. In still other embodiments, one or more of the procedures, the processes, and/or the activities of method 400 can be combined or skipped. In some embodiments, method 400 can be implemented by inventory system 320 (FIG. 3) and/or order system 310 (FIG. 3). In a number of embodiments, the fulfillment network can include a plurality of distribution centers. The plurality of distribution centers can be similar or identical to distribution centers 361-365 (FIG. 3). In some embodiments, any number of distribution centers can be used. In some embodiments, a quantity of the plurality of distribution centers in the fulfillment network can be greater than 30.

In some embodiments, a nested multinomial log it model can be created using one or more items described above. For example, each demand zone (e.g., a geographic zone such as described above) can have groups of nests of similar SKUs (such as via subcategory). Information about a set (or nest) of products is retrieved (block 402). Within each demand zone and category, the nest can include the set of products:

S={1,2, . . . ,N}

The attributes for each SKU within the set is retrieved (block 404). In some embodiments, each SKU i within a set of products S has a set of attributes:

{x₁ⁱ, . . . ,x_{K}ⁱ}

Information regarding a new SKU N+1 is received (block 406), including the attributes of SKU N+1. Therefore, new SKU N+1 would have the set of attributes:

{x₁^{N+1}, . . . ,x_{K}^{N+1}}

The overall demand for each geographic zone is determined (block 408). In some embodiments, there is a set of M demand zones:

Z={1,2, . . . ,M}

The overall demand comprises the demand of each zone 1 through M.

For customer of a zone z, there is a random utility function of purchasing an item i with attributes xₖⁱ as follows, where α_{z} is the zone-dependent variance, β_{k,z} varies across zones, and ε is an error term:

μ_{i,z}=α_{z}+β_{1,z}x₁ⁱ+ . . . +α_{K,z}x_{K}ⁱ+ε,∀i,z

μ_{i,z}=α_{z}+Σₖ₌₁^{K}β_{k,z}xₖⁱ+ε,∀i,z

Under a nested multinomial log it model, for a customer from zone z who makes a purchase in the assortment S, the probability of product i being purchased is given by the following equation:

$${P}_{i , z} ( S ) = \frac{{e}^{{u}_{i , z}}}{{\sum }_{j ∈ S} {e}^{{u}_{j , z}}}$$

$${P}_{i , z} ( S ) = \frac{{e}^{{α}_{z} + {\sum }_{k = 1}^{K} {β}_{k , z} {x}_{k}^{i}}}{{\sum }_{j ∈ S} {e}^{{u}_{j , z}}} = \frac{{v}_{i , z}}{{V}_{z} ( S )}$$

The terms ν_{i,z} and V_{z}(S) are considered the preference weights of product i and the total preference weight in zone z, respectively.

For a demand of the assortment S, there is a higher chance that the demand comes from the zone with the highest preference weight V_{z}(S). In other words, an assortment level demand is from zone z with the following probability:

$${Q}_{z} ( S ) = \frac{{V}_{z} ( s )}{{\sum }_{l ∈ z} {V}_{l} ( S )}$$

Q_{z}(S) is the geo-demand distribution for the entire assortment of products. At block 410, the geographic level demand for each product is determined. In some embodiments, the nested log it model is able to describe the geo-demand at both the product level and for the entire assortment.

If the demand forecast for the entire assortment is D, then the demand from zone z is given as Q_{z}(S)D. Under the nested log it model, there is P_{i,z}(S) probability that the customer chooses product i given the fact that a purchase happens in zone z. This leads to the following equation:

$$\frac{{D}_{i , z}}{D} = {Q}_{z} ( S ) {P}_{i , z} ( S ) , ∀ i ∈ S , z ∈ Z$$

By definition, the associated geo-demand distribution of product i satisfies the following equation:

$$\frac{{ω}_{i , z} ( S )}{{ω}_{i , l} ( S )} = \frac{{D}_{i , z}}{{D}_{i , l}} = \frac{{Q}_{z} ( S ) {P}_{i , z} ( S )}{{Q}_{l} ( S ) {P}_{i , l} ( S )} = \frac{{v}_{i , z}}{{v}_{i , l}} ∀ z , l ∈ Z$$

Because Σₗω_{i,l}(S)=1, the resulting equation is as follows:

$${ω}_{i , z} ( S ) = \frac{{v}_{i , z}}{{\sum }_{l ∈ z} {v}_{i , l}} = \frac{{e}^{{α}_{z} + {\sum }_{k = 1}^{K} {β}_{k , z} {x}_{k}^{i}}}{{\sum }_{l ∈ Z} {e}^{{α}_{z} + {\sum }_{k = 1}^{K} {β}_{k , z} {x}_{k}^{i}}} , ∀ i ∈ S , z ∈ Z$$

After the launch of a new SKU, a customer sees an assortment comprising the set S∪{N+1}, where N+1 is the new SKU. The geo-demand for the new item is estimated (block 412). Because customers over the zones might have different preferences, the new assortment level geo-demand is updated as follows:

$${Q}_{z} ( S ⋃ \{ N + 1 \} ) = \frac{{V}_{z} ( S ⋃ \{ N + 1 \} )}{{\sum }_{l ∈ Z} {V}_{l} ( S ⋃ \{ N + 1 \} )} = \frac{{V}_{z} ( S ) + {v}_{N + 1 , z}}{{\sum }_{l ∈ Z} {V}_{l} ( S ) + {v}_{N + 1 , l}}$$

Where ν_{N+1,z}=e^{u}^{_{N+1,z}}

Within zone z, the probability of a customer choosing new product i is as follows:

$${P}_{N + 1 , z} ( S ⋃ \{ N + 1 \} ) = \frac{{v}_{N + 1 , z}}{{V}_{z} ( S ) + {v}_{N + 1 , z}}$$

$${P}_{i , z} ( S ⋃ \{ N + 1 \} ) = \frac{{v}_{i , z}}{{V}_{z} ( S ) + {v}_{N + 1 , z}} , ∀ i ∈ S$$

The geo-demand for the new SKU can be derived as follows:

$${ω}_{N + 1 , z} = \frac{{v}_{N + 1 , z}}{{\sum }_{l ∈ Z} {v}_{N + 1 , l}} = \frac{{e}^{{α}_{z} + {\sum }_{k = 1}^{K} {β}_{k , z} {x}_{k}^{N + 1}}}{{\sum }_{l ∈ Z} {e}^{{α}_{z} + {\sum }_{k = 1}^{K} {β}_{k , z} {x}_{k}^{N + 1}}} , ∀ z ∈ Z \qquad ( 1 )$$

One can also confirm that the geo-demand for existing products are not affected as follows:

$${ω}_{i , z} ( S ⋃ \{ N + 1 \} ) = \frac{{v}_{i , z}}{{\sum }_{l ∈ Z} {v}_{i , l}} = {ω}_{i , z} ( S ) , ∀ i ∈ S , z ∈ Z$$

Once the geo-demand estimation is made, the new SKU can be allocated and physically distributed among the geographic zones and the distribution centers within each geographic zone according to the estimation (block 414).

Estimation

The geo-demand of a new SKU can be estimated using historical sales data D_{i,z}. The attributes for existing products comprise the matrix X=(x_{i,k}). Methods used to estimate geo-demand depend on whether the new SKUs attributes X_{N+1} belongs to the convex hull of X.

Due to the nature of products, their associated attributes can vary in number and type. For instance, apparel typically has only a few attributes, e.g., brand and color. In contrast, a sophisticated piece of electronics, such as a laptop computer, is often described by many attributes, such as brand, CPU, hard disk size, screen size, ports, graphics capabilities, operating system, and the like.

Items with Few Attributes

As the attributes of new products can be expressed as a convex combination of the attributes of the existing products, there exists a set of weights pᵢ that satisfies the following equation:

{(pᵢ,∀iεS)|Σ_{iεS}pᵢXᵢ=X_{N+1},Σ_{iεS}pᵢ=1}

The mean utility and preference weight of the new SKU N+1 in zone z can be described as follows, where Π symbolizes the product of the sequence:

μ_{N+1,z}=Σ_{iεS}pᵢμ_{i,z},∀zεZ

ν_{N+1,z}=e^{μ}^{_{N+1,z}}=Π_{iεS}ν_{i,z}^{p}^{ᵢ},∀zεZ

As a result, we need to estimate only the preference weights ν_{i,z}, instead of the parameters (α_{z},β_{k,z}). Given the sales D_{i,z}, the likelihood function is as follows:

$$L ( D \vert V ) = {\prod }_{i ∈ S} {\prod }_{z ∈ Z} {( \frac{{v}_{i , z}}{{\sum }_{i ∈ S} {\sum }_{z ∈ Z} {v}_{i , z}} )}^{{D}_{i , z}}$$

The log-likelihood function can be written as follows:

l(D|V)=Σ_{iεS}Σ_{zεZ}D_{i,z} ln ν_{i,z}−D ln(Σ_{iεS}Σ_{zεZ}ν_{i,z}), where

D=Σ_{iεS}Σ_{zεZ}D_{i,z}

The maximum likelihood estimation (MLE) to ν_{i,z} is therefore as follows:

$${\hat{v}}_{i , z} = ρ \frac{{D}_{i , z}}{D} , ∀ i ∈ S , z ∈ Z ,$$

where ρ is a constant.

The estimated geo-demand for a new SKU N+1 is given by the following equation:

$${\hat{ω}}_{N + 1 , z} = \frac{{\hat{v}}_{N + 1 , z}}{{\sum }_{l ∈ Z}^{ } {\hat{v}}_{N + 1 , l}} = \frac{{\prod }_{i ∈ S}^{ } {D}_{i , z}^{Pi}}{{\sum }_{l ∈ Z}^{ } {\prod }_{j ∈ S}^{ } {D}_{j , l}^{Pj}}$$

Items with Many Attributes

In some categories, some products might have more attributes than the assortment size. In other words, the attribute dimension is much larger than the sample size, e.g., the number of existing products. In such a case, parameter estimation can be performed. This can be done by solving the maximum likelihood estimators to parameters (α_{z}, β_{1,z}, . . . , β_{K,z}), ∀zεZ.

The likelihood function given the above observation is as follows:

L(D|α,β)˜Π_{zεZ}Q_{z}^{Σ}^{_{iεS}}^{D}^{_{i,z}}Π_{iεS}P_{i,z}^{D}^{_{i,z}}

L(D|α,β)=Π_{iεS}Π_{zεZ}(Q_{z}P_{i,z})^{D}^{_{i,z}}

The log-likelihood function is as follows:

l(α,β)=Σ_{zεZ}Σ_{iεS}D_{i,z}(α_{z}+Σₖ₌₁^{K}β_{k,z}xₖⁱ−ln(Σ_{lεZ}Σ_{jεS}e^{α}^{ᵢ}^{+Σ}^{ₖ₌₁}^{^{K}}^{β}^{_{k,l}}^{x}^{ₖ}^{^{j}}))

In the face of categorical attributes, it is common to have several factor levels as the values. For example, the brand of a laptop might be coded as {Asus, Dell, HP, Lenovo, and Toshiba}. Meanwhile, in order to interpret the categorical attributes in regression, each factor level may be coded as an attribute together with a binary indicator. It usually makes the attribute dimension larger than the sample size. Hence, we have to impose regularization in the estimation according to the purposes. In the following, we introduce two formulations suitable for factor identification and geo-demand prediction.

Understanding the factors that shape the geo-demand distribution is crucial in the integration of marketing and operations efforts. What follows is an optimization model that selects the attributes that primarily affect the geo-demand. In practice, some attributes are usually grouped together, such as categorical attributes. For instance, the attributes {Asus, Dell, HP, Lenovo, and Toshiba} form a group of brands and it may be desirable to consider those attributes together. Suppose we have G groups of attributes and the associated parameters that are organized as follows:

$${( αβ )}^{T} = ( \begin{matrix}{α}_{1} & ⋯ & {β}_{K , 1} \\ ⋮ & ⋱ & ⋮ \\ {α}_{Z} & ⋯ & {β}_{K , Z}\end{matrix} ) = {( {αβ}_{1} … {β}_{G} )}^{T}$$

Where β_{g}=(β_{z,k}, ∀zεZ, kεI_{g}) is the parameter matrix for group gεG. Note that the grouped attributes I_{g} need to contain only df_{g} attributes for a categorical factor with df_{g}+1 levels. That is, we need to group only 4 brand attributes if there are 5 brands in total.

We propose the following optimization problem with sparse group lasso:

min_{α,β}H(α,β)=−l(α,β)+λΣ_{gεG}∥β_{g}∥_{F}

Where l is the log-likelihood function, λ is a penalty parameter, and H is a notation for the new objective function.

Note that the objective above is non-differentiable and of higher dimension than that in the prior art. A transformation can be used to reduce the dimension of the matrix. The attribute matrix X is reorganized into block-diagonal matrix with Z times replication. Thereafter, we can column-vectorize the submatrices β_{g} as follows:

$$\tilde{X} = ( \begin{matrix}X & & \\ & X & \\ & & X\end{matrix} ) , \tilde{β} = ( \begin{matrix}{β}_{1} \\ ⋮ \\ {β}_{z}\end{matrix} )$$

We are able to rewrite the above equations as follows:

\tilde{l}(α,\tilde{β})=Σ_{zεZ}D_{z}α_{z}+Σ_{zεZ}Σ_{iεS}D_{i,z}Σₖ₌₁^{K}\tilde{β}_{k+(z-1)K}\tilde{X}_{i+(z-1)I,k+(z-1)K}

−D ln(Σ_{lεZ}Σ_{jεS}exp(αₗ+Σₖ₌₁^{K}\tilde{β}_{k+(l-1)K}\tilde{X}_{j+(l-1)I,k+(l-1)K}))

And

\tilde{H}(α,\tilde{β})=−\tilde{l}(α,\tilde{β})+λΣ_{gεG}∥\tilde{β}_{g}∥₂

Moreover, \tilde{β}_{g} consists of the k-th, the (k+z)-th, . . . , and the (k+(Z−1)K)-th entries in \tilde{β}, for all kεI_{g}

For the prediction purpose, we propose the MLE optimization model with ridge regression as follows:

min_{α,β}H(α,β)=−l(α,β)+λ∥β∥₂²

By setting λ to 0, the above equation solves the general MLE for α,β with output \hat{α},\hat{β}. The minimization can be implemented by calling function “nlm” (non-linear minimization) in the software program for statistical computing and graphics called R.

With the estimated parameters from either models proposed above, we can then estimate the new item geo-demand through equation (1) by replacing a, α,β with \hat{α},\hat{β}.

The above described nested log it model that is able to take product attributes in the estimation of new product geo-demand distribution. The estimated geo-demand is then used as a guiding reference in the inventory allocation for the online retailer.

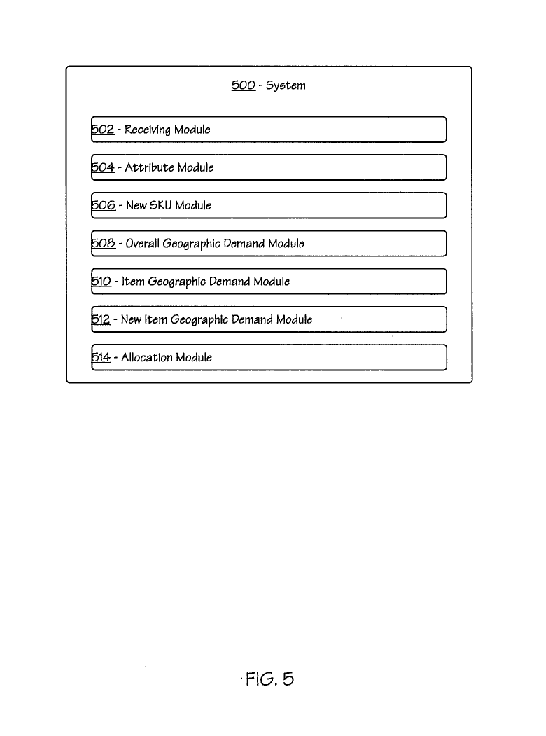

Turning ahead in the figures, FIG. 5 illustrates a block diagram of a system 500 that is capable of performing disclosed embodiments. System 500 is merely exemplary and is not limited to the embodiments presented herein. System 500 can be employed in many different embodiments or examples not specifically depicted or described herein. In some embodiments, certain elements or modules of system 500 can perform various procedures, processes, and/or acts. In other embodiments, the procedures, processes, and/or acts can be performed by other suitable elements or modules.

In a number of embodiments, system 500 can include receiving module 502. In certain embodiments, receiving module 502 can perform block 402 (FIG. 4) of receiving information regarding a set of SKUs.

In a number of embodiments, system 500 can include attribute module 504. In certain embodiments, attribute module 504 can perform block 404 (FIG. 4) of receiving attribute information regarding a set of SKUs.

In a number of embodiments, system 500 can include new SKU module 506. In certain embodiments, new SKU module 506 can perform block 406 (FIG. 4) of receiving information regarding a new SKU.

In a number of embodiments, system 500 can include overall geographic demand module 508. In certain embodiments, overall geographic demand module 508 can perform block 408 (FIG. 4) of determining overall geographic demand.

In a number of embodiments, system 500 can include item geographic demand module 510. In certain embodiments, item geographic demand module 510 can perform block 410 (FIG. 4) of determining geographic demand for each product.

In a number of embodiments, system 500 can include new item geographic demand module 512. In certain embodiments, new item geographic demand module 512 can perform block 412 (FIG. 4) of determining geographic demand for the new product.

In a number of embodiments, system 500 can include allocation module 514. In certain embodiments, allocation module 514 can perform block 414 (FIG. 4) of allocating the new item according to the estimation.

Although determining an inventory allocation plan has been described with reference to specific embodiments, it will be understood by those skilled in the art that various changes may be made without departing from the spirit or scope of the disclosure. Accordingly, the disclosure of embodiments is intended to be illustrative of the scope of the disclosure and is not intended to be limiting. It is intended that the scope of the disclosure shall be limited only to the extent required by the appended claims. For example, to one of ordinary skill in the art, it will be readily apparent that any element of FIGS. 1-5 may be modified, and that the foregoing discussion of certain of these embodiments does not necessarily represent a complete description of all possible embodiments. For example, one or more of the procedures, processes, or activities of FIGS. 1-5 may include different procedures, processes, and/or activities and be performed by many different modules, in many different orders. As another example, the modules within inventory system 320 in FIG. 1-5 can be interchanged or otherwise modified.

All elements claimed in any particular claim are essential to the embodiment claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

1. A system comprising:
one or more processing modules; and
one or more non-transitory memory storage modules storing computing instructions configured to run on the one or more processing modules and perform the acts of:
receiving information regarding a set of stock keeping units (SKUs) for an online retailer;
receiving information regarding one or more attributes for each SKU in the set of SKUs;
calculating an overall demand per zone of a plurality of zones for the set of SKUs;
calculating a demand per zone of the plurality of zones for each SKU in the set of SKUs;
finding an effect of each attribute of the one or more attributes on the demand per zone for each SKU in the set of SKUs;
receiving information regarding a new SKU;
receiving information regarding a set of attributes for the new SKU;
matching the set of attributes to at least one of the one or more attributes for each SKU in the set of SKUs;
estimating an effect of each attribute of the set of attributes based on the effect of each attribute of the one or more attributes of the at least one of the one or more attributes for each SKU in the set of SKUs;
estimating a demand per zone of the plurality of zones for the new SKU by applying a first set of rules to the set of attributes for the new SKU and the effect of each attribute of the set of attributes on the demand per zone;
allocating the new SKU to one or more distribution centers in at least one zone of the plurality of zones based on the estimated demand per zone of the plurality of zones for the new SKU to (1) minimize shipping costs to at least one of the online retailer or one or more customers ordering the new SKU, and (2) minimize transit time for the new SKU from the one or more distribution centers to a customer of the one or more customers; and
launching the new SKU on a website of the online retailer.

2. The system of claim 1 wherein the overall demand per zone is determined using a formula:
$${Q}_{z} ( S ) = \frac{{V}_{z} ( S )}{{\sum }_{l ∈ Z}^{ } {V}_{l} ( S )} ,$$
where Q_{z}(S) is a geo-demand distribution for a set of products S per a zone z, V_{z}(S) is a total preference weight, and Vₗ(S) is a demand for each zone of the plurality of zones.

3. The system of claim 2 wherein the demand from the zone z can be determined using a formula Q_{z}(S)D, where D is a demand forecast for an entire assortment of products.

4. The system of claim 1 wherein calculating the demand per zone for each SKU comprises:
determining a probability of a product i is chosen using a formula:
$${P}_{i , z} ( S ) = \frac{{v}_{i , z}}{{V}_{z} ( S )} ,$$
where P_{i,z}(S) is a probability of a product i from a set of products S being chosen in a zone z, ν_{i,z} is a preference weight of product i, and V_{z}(S) is a total preference weight in the zone z.

5. The system of claim 4 wherein estimating the demand per zone for the new SKU comprises:
estimating a new overall geo-demand; and
calculating a probability of the new SKU being chosen.

6. The system of claim 5 wherein estimating the new overall geo-demand comprises using a formula:
$${Q}_{z} ( S ⋃ \{ N + 1 \} ) = \frac{{V}_{z} ( S ⋃ \{ N + 1 \} )}{{\sum }_{l ∈ Z}^{ } {V}_{l} ( S ⋃ \{ N + 1 \} )} = \frac{{V}_{z} ( S ) + {v}_{N + 1 , z}}{{\sum }_{l ∈ Z}^{ } {V}_{l} ( S ) + {v}_{N + 1 , l}} ,$$
where Q_{z}(S∪{N+1}) is the new overall geo-demand for the set of products S comprising a union of the set of products S and the new SKU, and ν_{N+1,z} is a preference weight of the new SKU.

7. The system of claim 4 wherein finding the effect of each attribute of the one or more attributes on the demand per zone for each SKU in the set of SKUs further comprises determining a utility function as follows: μ_{i,z}=α_{z}+Σₖ₌₁^{K}β_{k,z}xₖⁱ+ε, ∀i, z, where α_{z} is a zone-dependent variance, and β_{k,z} is a weight for an attribute.

8. The system of claim 4 wherein the first set of rules comprises:
$${ω}_{N + 1 , z} = \frac{{v}_{N + 1 , z}}{{\sum }_{l ∈ Z}^{ } {v}_{N + 1 , l}} = \frac{{e}^{{α}_{z} + {\sum }_{k = 1}^{K} {β}_{k , z}^{ } {x}_{k}^{N + 1}}}{{\sum }_{l ∈ Z}^{ } {e}^{{α}_{z} + {\sum }_{k = 1}^{K} {β}_{k , z}^{ } {x}_{k}^{N + 1}} } ,$$
∀zεZ, where α_{z} is a zone-dependent variance, β_{k,z} is a weight for an attribute, and xₖⁱ is attribute k for item i.

9. The system of claim 8 wherein:
ν_{i,z}=e^{α}^{_{z}}^{+Σ}^{ₖ₌₁}^{^{K}}^{β}^{_{k,z}}^{x}^{ₖ}^{ⁱ}; and
V_{z}(S)=Σ_{jεS}e^{u}^{_{j,z}}.

10. The system of claim 1 wherein estimating the demand per zone for the new SKU comprises:
estimating preference weights for the new SKU using a formula:
$${\hat{v}}_{i , z} = ρ \frac{{D}_{i , z}}{D} ,$$
∀iεS, zεZ, where ρ is a constant, D represents overall sales, and D_{i,z} represents an estimated demand of item i in a zone z; and
estimating a geo-demand for the new SKU using a formula:
$${\hat{ω}}_{N + 1 , z} = \frac{{\hat{v}}_{N + 1 , z}}{{\sum }_{l ∈ Z}^{ } {\hat{v}}_{N + 1 , l}} = \frac{{\prod }_{i ∈ S}^{ } {D}_{i , z}^{{p}_{i}}}{{\sum }_{l ∈ Z}^{ } {\prod }_{j ∈ S}^{ } {D}_{j , l}^{{p}_{j}}} ,$$
where \hat{ω}_{N+1,z} is the geo-demand for the new SKU in the zone z.

11. The system of claim 1 wherein estimating the demand per zone for the new SKU comprises:
using parameter estimation to estimate an effect on demand of each attribute of the set of attributes by solving maximum likelihood estimators.

12. The system of claim 11 wherein:
the parameter estimation includes finding a minimum value for α and β that solves a log-likelihood function: min_{α,β} H(α,β)=−l(α,β), where α is a zone-dependent variance and β is a weight for an attribute.

13. A method being implemented via execution of computing instructions configured to run at one or more processors and configured to be stored at non-transitory computer-readable media, the method comprising:
receiving information regarding a set of stock keeping units (SKUs) for an online retailer;
receiving information regarding one or more attributes for each SKU in the set of SKUs;
calculating an overall demand per zone of a plurality of zones for the set of SKUs;
calculating a demand per zone of the plurality of zones for each SKU in the set of SKUs;
finding an effect of each attribute of the one or more attributes on the demand per zone for each SKU in the set of SKUs;
receiving information regarding a new SKU;
receiving information regarding a set of attributes for the new SKU;
matching the set of attributes to at least one of the one or more attributes for each SKU in the set of SKUs;
estimating an effect of each attribute of the set of attributes based on the effect of each attribute of the one or more attributes of the at least one of the one or more attributes for each SKU in the set of SKUs;
estimating a demand per zone of the plurality of zones for the new SKU by applying a first set of rules to the set of attributes for the new SKU and the effect of each attribute of the set of attributes on the demand per zone;
allocating the new SKU to one or more distribution centers in at least one zone of the plurality of zones based on the estimated demand per zone of the plurality of zones for the new SKU to (1) minimize shipping costs to at least one of the online retailer or one or more customers ordering the new SKU, and (2) minimize transit time for the new SKU from the one or more distribution centers to a customer of the one or more customers; and
launching the new SKU on a website of the online retailer.

14. The method of claim 13 wherein the overall demand per zone is determined using a formula:
$${Q}_{z} ( S ) = \frac{{V}_{z} ( S )}{{\sum }_{l ∈ Z}^{ } {V}_{l} ( S )} ,$$
where Q_{z}(S) is a geo-demand distribution for a set of products S per a zone z, V_{z}(S) is a total preference weight, and Vₗ(S) is a demand for each zone of the plurality of zones.

15. The method of claim 13 wherein calculating the demand per zone for each SKU comprises:
determining a probability of a product i is chosen using a formula:
$${P}_{i , z} ( S ) = \frac{{v}_{i , z}}{{V}_{z} ( S )} ,$$
P_{i,z}(S) is a probability of a product i from a set of products S being chosen in a zone z, ν_{i,z} is a preference weight of product i, and V_{z}(S) is a total preference weight in the zone z.

16. The method of claim 15 wherein estimating the demand per zone for SKU comprises:
estimating a new overall geo-demand; and
calculating a probability of the new SKU being chosen.

17. The method of claim 16 wherein estimating the new overall geo-demand comprises using a formula:
$${Q}_{z} ( S ⋃ \{ N + 1 \} ) = \frac{{V}_{z} ( S ⋃ \{ N + 1 \} )}{{\sum }_{l ∈ Z}^{ } {V}_{l} ( S ⋃ \{ N + 1 \} )} = \frac{{V}_{z} ( S ) + {v}_{N + 1 , z}}{{\sum }_{l ∈ Z}^{ } {V}_{l} ( S ) + {v}_{N + 1 , l}} ,$$
where Q_{z}(S∪{N+1}) is a new overall geo-demand for the set of products S comprising a union of the set of products S and the new SKU and ν_{N+1,z} is a preference weight of the new SKU.

18. The method of claim 15 wherein the first set of rules comprises:
$${ω}_{N + 1 , z} = \frac{{v}_{N + 1 , z}}{{\sum }_{l ∈ Z}^{ } {v}_{N + 1 , l}} = \frac{{e}^{{α}_{z} + {\sum }_{k = 1}^{K} {β}_{k , z}^{ } {x}_{k}^{N + 1}}}{{\sum }_{l ∈ Z}^{ } {e}^{{α}_{z} + {\sum }_{k = 1}^{K} {β}_{k , z}^{ } {x}_{k}^{N + 1}} } ,$$
∀zεZ, where α_{z} is a zone-dependent variance, and β_{k,z} is a weight for an attribute, and xₖⁱ is attribute k for item i.

19. The method of claim 18 wherein:
ν_{i,z}=e^{α}^{_{z}}^{+Σ}^{ₖ₌₁}^{^{K}}^{β}^{_{k,z}}^{x}^{ₖ}^{ⁱ}; and
V_{z}(S)=Σ_{jεS}e^{u}^{_{j,z}}.

20. The method of claim 13 wherein estimating the demand per zone for the new SKU comprises:
estimating preference weights for the new SKU using a formula:
$${\hat{v}}_{i , z} = ρ \frac{{D}_{i , z}}{D} ,$$
∀iεS, zεZ, where ρ is a constant, D represents overall sales, and D_{i,z} represents an estimated demand of item i in a zone z; and
estimating a geo-demand for the new SKU using a formula:
$${\hat{ω}}_{N + 1 , z} = \frac{{\hat{v}}_{N + 1 , z}}{{\sum }_{l ∈ Z}^{ } {\hat{v}}_{N + 1 , l}} = \frac{{\prod }_{i ∈ S}^{ } {D}_{i , z}^{{p}_{i}}}{{\sum }_{l ∈ Z}^{ } {\prod }_{j ∈ S}^{ } {D}_{j , l}^{{p}_{j}}} ,$$
where \hat{ω}_{N+1,z} is the geo-demand for the new SKU in the zone z.
